(19) United States
(12) Patent Application Publication
(10) Pub. No.: US 2021/0383387 A1
(43) Pub. Date: Dec. 9, 2021

(54) NAME VERIFICATION SERVICE

(71) Applicant: Visa International Service Association, San Francisco, CA (US)

(72) Inventors: Adam Grant Ratica, Mentor, OH (US); Chandra S. Balasubramanian, Shaker Heights, OH (US); Christopher A. Baird, South Euclid, OH (US); Francis M. Sherwin, II, Shaker Heights, OH (US); Richard Nicholas Ziolkowski, Mentor, OH (US); James J. Houlihan, JR., Naperville, IL (US)

(21) Appl. No.: 16/896,598

(22) Filed: Jun. 9, 2020

(51) Int. Cl. G06Q 20/40; G06Q 40/02; G06F 16/245; H04L 29/06

(52) U.S. Cl. CPC G06Q 20/4014; G06Q 40/02; H04L 63/126; G06F 16/245; G06Q 20/4016

(57) ABSTRACT

A method is provided for verifying a cardholder name associated with a payment device used in connection with a card-not-present transaction. The method includes the steps of maintaining a database including a plurality of records pertaining to historically processed transactions, receiving, at a name verification server, a cardholder name verification request including a submitted primary account number of a payment device and a submitted cardholder name, querying the database to identify one or more records that include an indication of a primary account number that matches the submitted primary account number included in the cardholder name verification request, comparing at least one cardholder name in the identified one or more records to the submitted cardholder name included in the cardholder name verification request, determining whether or not there is a sufficient match resulting from said comparing, generating a name verification response, and sending the name verification response to the merchant server.

### BACKGROUND

### 1. Field

The subject matter of the present specification generally relates to the art of identity verification.

### 2. Technical Considerations

Generally, in connection with credit card, debit card, and/or other like payment instrument transactions conducted over telecommunications networks (e.g., including without limitation wired and/or wireless networks, the Internet, WiFi®, cellular networks, disparate systems, private networks, etc.), there are certain issues which can arise with regard to authenticating the identity of a purported cardholder, e.g., verifying that a user is in fact the person they purport to be, namely, an authentic cardholder. Indeed, such difficulties typically arise because the transaction is conducted over the network (for example, the transaction is not conducted face-to-face between the customer and merchant involved in the transaction). As such, the physical card is generally not available to the merchant. This type of transaction is commonly referred to in the payment's industry as a card-not-present (CNP) transaction.

Due to the associated costs and liabilities, it is generally desirable to eliminate and/or limit the occurrence of fraud in CNP transactions. CNP transactions can be a significant avenue for fraud because of difficulties a merchant may have in verifying that the actual cardholder is indeed making a purchase.

If a card is not physically present when a customer makes a purchase, the merchant must rely on the customer (e.g., someone purporting to be a cardholder) to accurately provide card information indirectly, e.g., over the Internet. Commonly, in connection with CNP transactions (e.g., conducted over the Internet), customers are required to provide their name, address, card number, card expiration date, and sometimes a card security code (CSC) in order to process and/or complete the CNP transaction. For example, depending on the type of card, the CSC may be, without limitation: a Card Identification Number or Code (CID), a Card Validation Code (CVC2), Card Verification Data (CVD), or Card Verification Value (CVV2). Typically, Internet merchants (e.g., such as travel agencies, airlines, online retailers, dating sites, digital download sites, etc.) send the pertinent data listed above during the authentication and/or authorization processes to an issuing bank (i.e., the institution which issued the card to the cardholder), optionally through the merchant's card processor. The issuing bank may then verify the relevant data against its records and report back to the merchant the results thereof.

Generally, a security code is not strictly required. For example, VISA® and/or MasterCard® do not demand the use of a security code, but it is strongly encouraged and widely adopted. Moreover, what is known in the payments industry as Address Verification Service (AVS) is not required and only required by US issuers to support—not issuers in other countries.

Notwithstanding the foregoing, one element listed above that is not sent to the issuing bank in connection with CNP transactions is the cardholder name even though a customer may be prompted to provide their name “as it appears on the card.” Indeed, heretofore, there has been no suitable process that existed in an automated and/or real-time manner to verify and/or validate that the name provided by a customer in connection with a CNP transaction sufficiently matches the actual name associated with the relevant card. Such a lack of name verification in connection with CNP transactions can be particularly troubling to merchants that provide digital and/or non-physical goods and/or services (e.g., airline, sporting event or concert tickets, etc.) which may be issued in the name of a person making the purchase.

For physical goods which generally require an actual address for the physical goods to be shipped to, a verification that a provided “ship to” address matches the “billing address” associated with a card can serve to ensure to a somewhat reasonable degree of reliability that the customer is in fact the cardholder he purports to be. However, with digital and/or non-physical goods and/or services, there is generally no actual shipping address to which the goods and/or services are actually sent.

An AVS can sometimes be used to somewhat verify that a billing address associated with a payment device is valid. However, AVS as it is currently used in large part is limited to matching the numeric values in the street address and zip code, and it is further limited to a select number of countries. Accordingly, in many circumstances, address verification may not suffice to detect and/or deter fraudulent CNP transactions.

Consider, for example, the scenario of an airline that sells tickets online for travel. Presumably, at the time the CNP transaction is being conducted, the airline asks a customer, John Doe, for the information listed above. Assume John Doe provides Bill Jones' credit card number and address, but provides the name John Doe in both the “name on card” and “traveler/passenger” fields during the purchase. When the authentication and/or authorization request is made to the issuing bank, if there is a sufficient address match and/or security code match and sufficient funds are available, then the issuing bank will presumably respond to the airline with a suitable verification. Consequently, the airline will presumably issue the ticket in the name of John Doe for travel. In this instance, the merchant does not have an automated way to verify or validate that “John Doe” is or is not in fact the named cardholder of record at the issuing bank. For example, if the airline was able to verify/validate that John Doe wasn't the name of the cardholder on file with the issuing bank, the airline could either ask for another form of payment, or request some clarification as to the discrepancy, or simply decline the transaction, thus attempting to prevent a potential fraud from occurring.

### SUMMARY

This Summary is provided to introduce concepts related to the present specification. It is not intended to identify essential features of the claimed subject matter nor is it intended for use in determining or limiting the scope of the claimed subject matter. The exemplary embodiments described below are not intended to be exhaustive or to limit the claims to the precise forms disclosed in the following Detailed Description. Rather, the embodiments are chosen and described so that others skilled in the art may appreciate and understand the principles and practices of the subject matter presented herein.

In accordance with one exemplary embodiment, a method is provided for verifying a cardholder name associated with a payment device used in connection with a card-not-present transaction. The method includes: maintaining a database including a plurality of records pertaining to historically processed transactions, each record including an indication of a primary account number of a payment device and a cardholder name used to conduct the transaction to which the record pertains; receiving at a name verification server a cardholder name verification request sent over a data communications network from a merchant server, the cardholder name verification request including a submitted primary account number of a payment device and a submitted cardholder name; querying the database to identify one or more records that include an indication of a primary account number that matches the submitted primary account number included in the cardholder name verification request; comparing at least one cardholder name in the identified one or more records to the submitted cardholder name included in the cardholder name verification request; making a determination if there is a sufficient match resulting from the comparing; generating a name verification response, wherein a content of the name verification response is established at least partially based on the determination; and sending the name verification response to the merchant server over the data communications network.

In accordance with another exemplary embodiment, a computer system is provided for verifying a cardholder name associated with a payment device used in connection with a card-not-present transaction. The system includes: a database including a plurality of records pertaining to historically processed transactions, each record including an indication of a primary account number of a payment device and a cardholder name used to conduct the transaction to which the record pertains; and a name verification server implemented on a computer. The name verification server is operative to: receive a cardholder name verification request sent over a data communications network from a merchant server, the cardholder name verification request including a submitted primary account number of a payment device and a submitted cardholder name; query the database to identify one or more records that include an indication of a primary account number that matches the submitted primary account number included in the cardholder name verification request; compare at least one cardholder name in the identified one or more records to the submitted cardholder name included in the cardholder name verification request; make a determination whether or not there is a sufficient match resulting from the comparison; generate a name verification response, wherein a content of the name verification response is established at least partially based on the determination; and send the name verification response to the merchant server over the data communications network.

Numerous advantages and benefits of the subject matter disclosed herein will become apparent to those of ordinary skill in the art upon reading and understanding the present specification. It is to be understood, however, that the detailed description of the various embodiments and specific examples, while indicating preferred and/or other embodiments, are given by way of illustration and not limitation.

### BRIEF DESCRIPTION OF THE DRAWINGS

The following Detailed Description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings are not to scale.

FIG. 1A is a diagrammatic illustration showing one exemplary embodiment of a system for carrying out name verification services in accordance with aspects of the present inventive subject matter.

FIG. 1B is a diagrammatic illustration showing another exemplary embodiment of a system for carrying out name verification services in accordance with aspects of the present inventive subject matter.

FIG. 2 is a flow chart showing one exemplary process for carrying out a name verification service in accordance with aspects of the present inventive subject matter.

FIG. 3 is a flow chart showing the generation hash_ID from a PAN according to an exemplary embodiment of the present inventive subject matter.

FIG. 4 is a flow chart showing an exemplary process for producing a response reliability score according to an embodiment of the present inventive subject matter.

### DETAILED DESCRIPTION

For clarity and simplicity, the present specification shall refer to structural and/or functional elements, relevant standards, algorithms and/or protocols, and other components, methods, and/or processes that are commonly known in the art without further detailed explanation as to their configuration or operation except to the extent they have been modified or altered in accordance with and/or to accommodate the preferred and/or other embodiment(s) presented herein. Moreover, the apparatuses and methods disclosed in the present specification are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific materials, techniques, arrangements, etc. are either related to a specific example presented or are merely a general description of such a material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to the figures.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. It will be appreciated that numerous other arrangements are possible.

As used herein, the term “computing device” or may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “graphical user interface” (GUI) refers to a generated display, such as one or more displays with which a user may interact, either directly or indirectly (e.g., through a keyboard, mouse, touchscreen, etc.).

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as VISA® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “issuer institution” and/or “issuing bank” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a payment device, such as a physical financial instrument, e.g., a payment device, and/or may be electronic and used for electronic payments. The term “issuer system” refers to one or more computing devices operated by or on behalf of an issuer institution, such as a server computer executing one or more software applications. For example, an issuer system may include one or more authorization servers for authorizing a transaction.

As used herein, the term “account identifier” may include one or more PANs, tokens, or other identifiers associated with a customer account. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments, the payment device may include volatile or non-volatile memory to store information (e.g., an account identifier, a name of the account holder, and/or the like).

Non-limiting embodiments disclosed herein provided for a new and improved system, method, and computer program product for verifying an identity of a purported cardholder in connection with a CNP transaction. Non-limiting embodiments disclosed herein address specific problems that arise in electronic payment processing networks with CNP transactions pertaining to digital goods and services. Through the disclosed novel arrangement of systems, devices, and communications between the same, reliable name verification is provided in the context of an electronic payment processing network. Reliable name verification during the processing of a CNP transaction reduces fraudulent charges and, as a result, significantly reduces the amount of computational and network resources used to address the fraud through either other fraud detection systems and/or through processing disputes and chargebacks.

Non-limiting, exemplary embodiments disclosed herein find particular application in conjunction with identity authentication and/or verification in connection with the processing of a credit card, debit card, or other payment instrument transactions conducted via a data communications network, and they will be described herein with particular reference thereto. More specifically, certain embodiments rely on the use of a reputation to facilitate authentication (e.g., the leveraging to some degree of historical transaction data to compare current transaction data against (e.g., in real-time)). However, it is to be appreciated that various exemplary embodiments such as those disclosed herein are also amenable to other like applications.

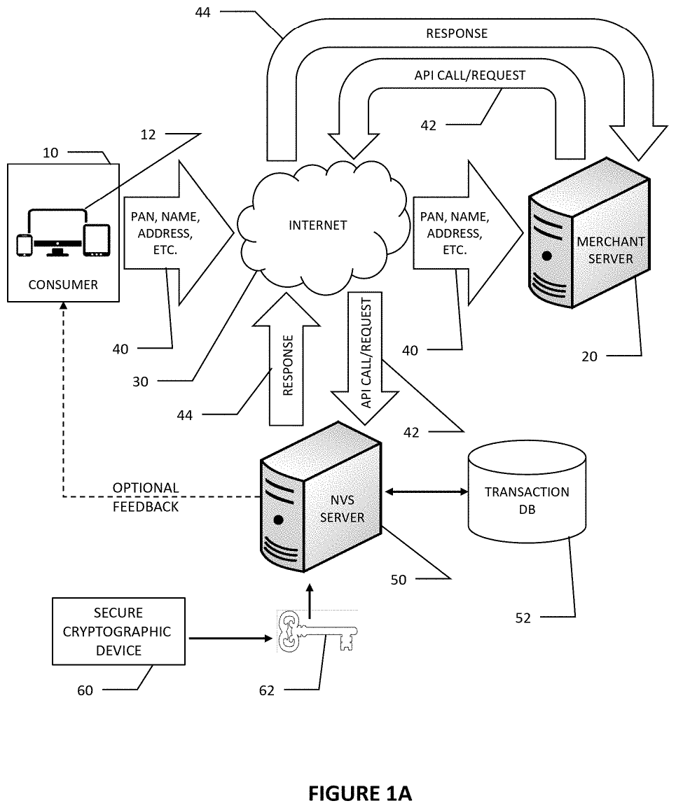

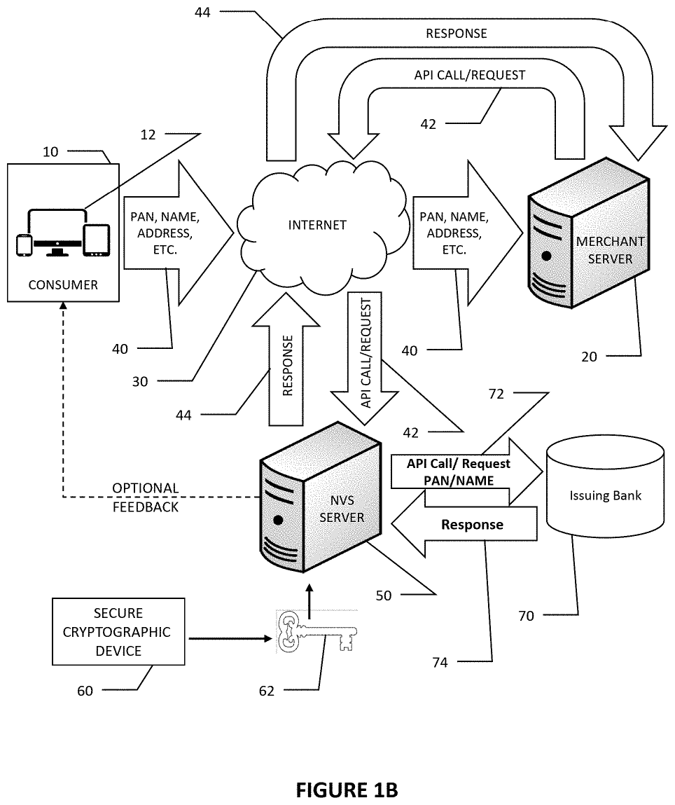

With reference to FIGS. 1A and 1B, there is shown generally a system for providing a name verification service according to non-limiting embodiments or aspects in connection with the processing of CNP transactions.

In practice, a customer or consumer 10 employs an Internet enabled or similar network capable device 12 (e.g., a computing device, such as a tablet or smart phone) to access and/or operatively connect with a merchant's server 20, e.g., over the Internet 30 or other suitable data telecommunications network. For example, the device 12 may be provisioned with and/or running a suitable web browser or the like which accesses via the Internet 30 an online shopping website and/or one or more webpages provided by the server 20. In one suitable embodiment, the merchant's server 20 providing the website to the device 12 may be provisioned with a virtual or digital shopping cart allowing the customer 10 to select one or more items for purchase from the online shopping website. When the customer 10 has completed shopping, they may use their device 12 to navigate to a “check-out” page provided by the merchant's server 20. At the time of check out, the “check-out” page provided to the device 12 by the server may prompt the customer 10 to select a payment option from one or more different types, e.g., including one or more different credit, debit, and/or other payment device options. In some non-limiting embodiments, the device 12 may be provisioned with and/or running a dedicated software application, such as a merchant-specific mobile application, that is served with structured data from the server 20.

Upon selecting a payment option, the customer 10 is prompted to enter certain payment information 40 for the selected payment option and optionally certain order fulfillment information. In practice, the payment information 40 suitably includes a PAN or other account identifier associated with a payment device corresponding to the selected payment option, a name of the cardholder (e.g., the name of the cardholder “as it appears on the payment device”), a billing address associated with the payment device, an expiration date of the payment device, and a CSC for the payment device. The order fulfillment information optionally includes a shipping address (e.g., identifying where physical goods may be shipped) and an order name (e.g., a name for which digital goods and/or non-physical goods and/or services are to be issued). For example, the order name may be the name of an individual for which airline, concert, sporting event, and/or other like tickets are to be issued.

As illustrated, the entered payment information 40 is communicated from the device 12 over the Internet 30 to the merchant's server 20. Upon receipt of the payment information 40, the merchant's server 20 suitably invokes a name verification service (NVS) in order to verify and/or validate that the cardholder name supplied in the payment information is indeed an authentic cardholder name associated with the PAN supplied in the payment information.

Suitably, upon invoking the name verification service, a request 42 (e.g., an application program interface (API) call) is sent from the merchant's server 20 to an NVS server 50 which carries out a name verification process and returns a corresponding response 44 (e.g., a result) to the merchant's server 20. As shown, the request 42 and response 44 are exchanged between the merchant's server 20 and the NVS 50 via the Internet 30. In practice, the request 42 may include, without limitation: the identity of the merchant involved in the transaction, the payment information supplied for the transaction, and/or a corresponding time and/or date stamp for the transaction.

For the sake of clarity and simplicity, as shown in FIGS. 1A and 1B, only a single customer 10 and single merchant's server 20 are illustrated. However, it is to be appreciated that in practice a plurality of different yet similarly situated customers may likewise be transacting with the merchant's server 20 and/or a plurality of different yet similarly situated merchants' servers. Optionally, merchant gateways, marketplaces, and/or other third parties acting on behalf of the merchant may stand in for the merchant and/or operate or host the server 20 where appropriate. In any event, as can be appreciated, over time the name verification server 50 performs a multitude of name verification processes in connection with transactions conducted between various different combinations of customers and merchants. In practice, a record of the relevant details is made and kept corresponding to each transaction for which the NVS server 50 is called upon to perform the name verification. As shown, these transaction records are stored and maintained in a transaction database (DB) 52 (or data warehouse) to which the NVS server 50 has access.

Suitably, the NVS server 50 updates the DB 52 in an ongoing fashion as name verification services are provided thereby. Each record suitably includes, without limitation: the data provided in the request 42 and optionally the corresponding response 44. In one suitable embodiment, prior to storage in the DB 52, a hash is applied to the PAN (e.g., by the NVS server 50) to generate a corresponding hash_ID for the PAN. While the specification specifically refers to a hash_ID, it is to be appreciated that another like non-reversible PAN representation may similarly be generated and/or employed.

In accordance with one suitable embodiment, in the corresponding record, the hash_ID is substituted for the PAN from which the hash_ID was generated. In this way, actual PANs are not maintained in the DB 52, but rather the corresponding hash_IDs are maintained in the DB 52 in place of the PANs. As such, should the DB 52 be breached or otherwise accessed inappropriately, the PANs are not readily discernable and/or obtainable therefrom. In this way, for example, the PANs are protected in case the DB 52 is compromised.

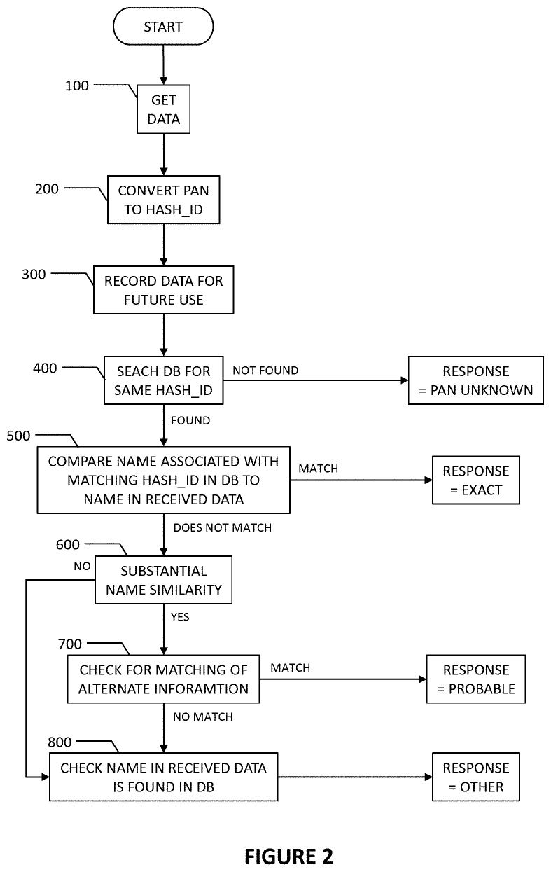

With additional reference now to FIG. 2, in general, the NVS server 50 accesses the historical records maintained in the DB 52 to perform the name verification.

As shown, the name verification process begins at step 100 with the NVS server 50 receiving the data in the request 42 sent from the merchant server 20. Suitably, at step 200, the PAN received in the request 42 is converted to a corresponding hash_ID, and at step 300, a record for the transaction is create and stored in the DB 52 for future use.

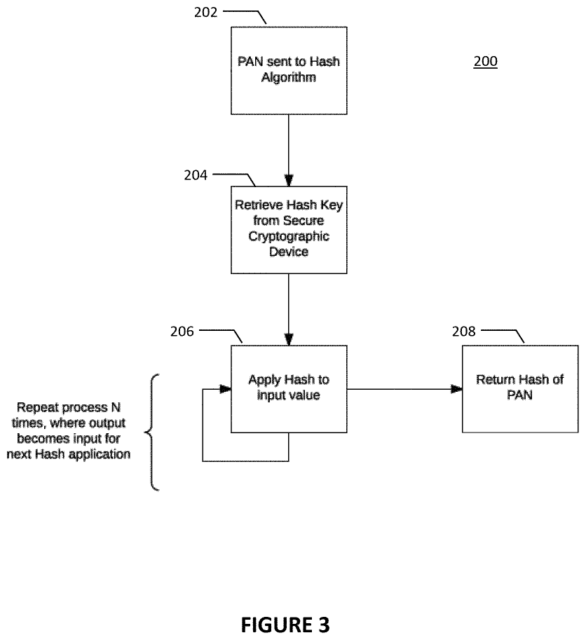

With additional reference now to FIG. 3, there is shown an exemplary process by which (the NVS server 50, for example) generates the hash_ID from the received PAN, e.g., the process by which step 200 is carried out. More specifically, at sub-step 202 the PAN received in the request 42 is input into a suitable hash algorithm. At sub-step 204, a hash key 62 (see FIG. 1) is retrieved from a secure cryptographic device 60 (see FIG. 1). At sub-step 206, using the retrieved hash key 62, the hash algorithm is repeatedly applied a number of times, with the input PAN being this initial value to which the hash is applied and subsequent inputs being the preceding output of the algorithm. At sub-step 208, after the hash algorithm has been run for the given number of cycles, the final output is returned as the corresponding hash_ID for the initially input PAN.

Note, that while the present specification refers to a hash_ID and a particular exemplary process for producing the same, it is to be appreciated that in practice other methods and/or techniques may be used to obscure the PAN and/or generate a PAN “alias,” e.g., in accordance with the Payment Card Industry (PCI) Security Standards promulgated by the PCI Security Standards Council and/or other such guidelines. Alternatively, in suitable circumstances (e.g., where data security is not a sufficient consideration and/or other suitably sufficient data security measures are enacted), the PAN itself may be employed unobscured.

Returning attention to FIG. 2, at step 400, the NVS server 50 conducts a search of the DB 52 for a hash_ID which matches the generated hash_ID corresponding to the PAN received in the request 42 being processed. If no suitable match is found, the NVS server 50 returns an appropriate response 44 to the merchant server 20 indicating, e.g., that the PAN is unrecognized or unknown. That is to say, the response 44 in this case indicates the NVS server 50 has not previously encountered the PAN in question.

If a suitable match is found in step 400, processing continues to step 500. At step 500, the cardholder name from the record with the matching hash_ID in the DB 52 and the cardholder named received in the request 42 being processed are compared to one another. Provided an identical match and/or sufficiently similar match is found with respect to the compared cardholder names, the NVS server 50 returns an appropriate response 44 to the merchant server 20 indicating, e.g., that the cardholder name in the request 42 is an exact or sufficiently similar match to the cardholder name historically accompanying the corresponding PAN (or more precisely it's hash_ID) in the DB 52.

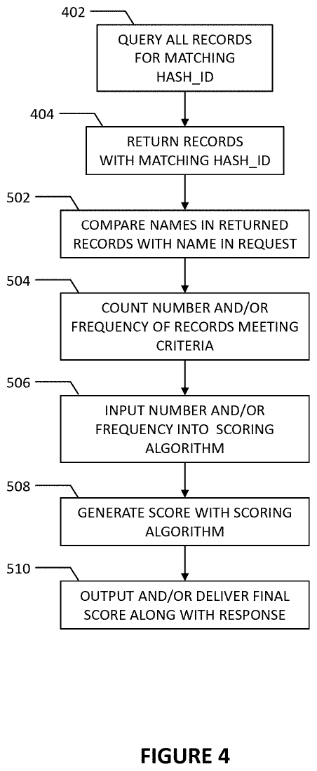

As can be appreciated, the DB 52 may contain a plurality of records corresponding to multiple transactions where the same payment device was employed over time. Accordingly, upon searching for a matching hash_ID (e.g., in step 400), multiple records satisfying the match criteria may be found. In this case, the NVS server 50 may use the number and/or frequency of qualifying records to generate a score which represent a relative confidence and/or reliability of the given verification response 44. An exemplary scoring process (e.g., carried out by the NVS server 50) is illustrated with additional reference now to FIG. 4.

As shown, at step 402, all records in the DB 52 are queried to find those records with hash_IDs that suitably match the hash_ID corresponding to the PAN received in the request 42 currently being processed. Then at step 404, all such records are returned. Further, at step 502, the cardholder names included in the returned records from the DB 52 and the cardholder name received in the request 42 currently being processed are compared to identify those records where there is an exact or sufficiently similar match therebetween. At step 504, the number of such identified records and/or the frequency of transactions (which may include a number of transaction per most recent week, month, year, etc.) corresponding to such identified records are calculated and/or otherwise determined. At step 506, the number and/or frequency obtained in step 504 are input into a suitable scoring algorithm. At step 508, the scoring algorithm uses the input number and/or frequency to generate a score, which represents a relative confidence and/or reliability of the given verification response 44. For example, when a matching cardholder name appears along with a matching hash_ID in the records of the DB 52 many times and/or frequently, it may be safer to conclude that the matching name is in fact the authentic cardholder for the PAN corresponding to that hash_ID. Accordingly, a stronger score may be generated in such cases. Conversely, when a matching cardholder name appears along with a matching hash_ID in the records of the DB 52 relatively few times and/or relatively infrequently, it may be relatively less safe to conclude that the matching name is in fact the authentic cardholder for the PAN corresponding to that hash_ID. Accordingly, a relatively weaker score may be generated in such cases. Optionally, other criteria and/or factors are considered in generating the confidence score. For example, more recent transactions in the DB 52 may be given a relatively greater weight than relatively older transactions when the score is calculated.

In either case, at step 510, a final score generated by the scoring algorithm is output and delivered, e.g., to the merchant's server 20 along with the response 44. Suitably, the score may also be logged into a score warehouse or other data storage device for future reference and/or use. Optionally, the scores may be stored in the DB 52, e.g., along with the record for which the score was generated.

Returning attention now to FIG. 2, if at step 500 there is no exact match or no sufficiently similar match (e.g., between the cardholder name associated with the matching hash_ID in the DB 52 found in step 400 and the cardholder named received in the request 42 being processed), then the process continues to step 600. At step 600, it is determined if the cardholder name (while not sufficiently similar for an exact match) is still similar enough to warrant further processing. For example, if the cardholder name in the request 42 is “John Doe”, while the name obtained from the DB 52 is “Jon G. Doe”, it might be considered that there is not a sufficiently similarity to warrant a so-called “exact” or “sufficiently similar” designation in the response 44. However, there is still enough similarity to warrant further processing. That is to say, in the case of the middle initial, it was simply omitted in the one instance, and in the case of the first name, it was simply a typographical error.

In the case that the result of a comparison between the respective cardholder names in step 600 results in a determination that the names are too dissimilar to warrant further processing, the process branches to step 800. Otherwise, if it results in a determination that the compared cardholder names are still similar enough to warrant further processing, the process continues to step 700.

At step 700, alternate information and/or data is optionally compared and/or checked for sufficient matches. For example, such alternate information may include, without limitation: email addresses, telephone numbers, delivery or ship-to addresses and/or billing addresses, and/or other order fulfillment information which may have optionally been submitted along with the request 42 to the NVS server 50 from the merchant server 20. Likewise, in connection with previously processed requests, the aforementioned alternate data and/or information may have also likewise been supplied to the NVS server 50 and stored in the DB 52 along with the records created for previous transactions.

Accordingly, if the compared alternate information results in one or more sufficient matches, then a response 44 may be returned, e.g., indicating that while the cardholder names do not match other alternate information sufficiently match and as such it can be considered to some degree probable and/or likely that the cardholder named in the request is still in fact the actual and/or authentic cardholder.

By the time the process reaches step 800, it has been determined that while a matching hash_ID has been found in at least one record in the DB 52, the cardholder name contained in the record having the matching hash_ID does not sufficiently match the cardholder name provided in the request 42 currently being processed. Accordingly, at step 800, the DB 52 is queried to check for cardholder names that sufficiently match the cardholder name supplied with the request 42, irrespective of the hash_ID associated with cardholder names in the various records of the DB 52. If no such match is found, a response may be returned to the merchant server 20, e.g., indicating that while the hash_ID and/or corresponding PAN has been previously processed, the cardholder name supplied in the request 42 does not sufficiently match the cardholder name(s) previously connected and/or used with the hash_ID and/or PAN. In this case, it can be concluded and/or the response 44 may indicate that the cardholder name was not verified and/or there is a reasonable suspicion that the consumer 10 is not in fact the authentic cardholder. Additionally, the response 44 in this case may also indicate that no cardholder name sufficiently matching the cardholder name supplied with the request 42 was found in the DB 52. Alternately, if at step 800, a matching cardholder name is found in the DB 52, but the record shows that cardholder name along with a different hash_ID, the response 44 may so indicate.

In some non-limiting embodiments, the way and/or manner in which the cardholder name and/or other payment information 40 and/or data is input to the merchant server 20 is suitably detected and used to regulate the tolerance employed in conjunction with the name matching and/or comparison. That is to say, certain payment information 40 may be entered manually (for example, with particular keystrokes) and/or certain payment information 40 may be enter via an autocomplete or similar function. For example, if autocomplete is used, it could be detected if javascript is enabled by looking at the keypress events. As can be appreciated, when autocomplete is used then there may be a reasonable expectation that typographical errors upon entering the payment information 40 and the cardholder name would not be a significant factor. Accordingly, the tolerance in the name matching could be relatively low, e.g., the cardholder names should exactly match or very close to exactly match in order for the name to be validated. Conversely, when manual data entry is detected, the possibility for typographical errors may be deemed relatively more likely (as compared to the autocomplete case). Therefore, name matching tolerances may be relaxed so that a relatively less exact matching of the cardholder names may still give rise to a response 44 indicating that sufficient validation of the cardholder name has been achieved.

With reference now particularly to FIG. 1B, there is illustrated an alternative non-limiting embodiment similar to the non-limiting embodiment of FIG. 1A. In the alternative embodiment, the historic transaction details may not be maintained in a transaction DB 52. Rather, an issuing bank 70 is queried and/or consulted to obtain the cardholder name associated with a given PAN. Generally, the issuing bank 70 maintains a record of the PAN and associated cardholder name for each payment device or other like payment instrument the bank 70 issues. Accordingly, when the NVS server 50 is processing a request to validate the cardholder name associated with a given PAN, the NVS server 50 in turn queries the issuing bank 70. For example, as shown in FIG. 1B, the NVS server 50 suitably submits an API call and/or other similar request 72 to the issuing bank 70, and the issuing bank 70 returns a suitable response 74 to the NVS server 50.

In practice, the request 72 may include merely the PAN which is currently being processed by the NVS server 50. In this case, the issuing bank 70 returns a response 74 which includes the cardholder name associated with the PAN received in the request 72 according the bank's records. Accordingly, the NVS server 50 compares the cardholder name received in the response 74 and the cardholder name received along with the request 42. If there is an exact or sufficiently similar match between the compared cardholder names, the response 44 will so indicate (e.g., the cardholder name is valid). Likewise, if there is not an exact or sufficiently similar match between the compared cardholder names, the response 44 will so indicate (e.g., the cardholder name is not valid).

Alternatively, the request 72 may include both the PAN and cardholder name received by the NVS server 50 along with the request 42. In this case, the issuing bank 70 may compare the received PAN and cardholder name against the bank's records. Having so consulted its own records, the response 74 returned to the NVS server 50 from the issuing bank 70 suitably indicates that the cardholder name suitably matches the name associated with the PAN in the bank's records (e.g., the cardholder name is valid) or alternately that the cardholder name does not suitably match the name associated with the PAN in the bank's records (e.g., the cardholder name is not valid). Suitably, the NVS server 50 translates and/or interprets the response 74 received from the issuing bank 70 and sends a corresponding response 44 to the merchant server 20.

Various aspects of the subject matter have been described herein with reference to exemplary and/or preferred embodiments. Modifications and alterations will occur to others upon reading and understanding the preceding detailed description. It is intended that the inventive subject matter be construed as including all such modifications and alterations insofar as they come within the scope of the appended claims or the equivalents thereof.

The above methods, system, platforms, modules, processes, algorithms, and/or apparatus have been described with respect to particular embodiments. It is to be appreciated, however, that certain modifications and/or alterations are also contemplated. Moreover, certain nomenclature has been used herein with reference to various messages, information, and/or data. Such nomenclature is merely used herein for purposes of illustration and/or example, and in practice, other like messages, information and/or data are contemplated regardless of the name or label applied thereto so long as it otherwise functions and/or represents its object similarly.

It is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, methods, functions, elements, and/or components described herein may suitably be implemented via hardware, software, firmware, or a combination thereof. In particular, various modules, components, and/or elements may be embodied by processors, electrical circuits, computers, and/or other electronic data processing devices that are configured and/or otherwise provisioned to perform one or more of the tasks, steps, processes, methods, and/or functions described herein. For example, a processor, computer, or other electronic data processing device embodying a particular element may be provided, supplied, and/or programmed with a suitable listing of code (e.g., such as source code, interpretive code, object code, directly executable code, and so forth) or other like instructions or software or firmware, such that when run and/or executed by the computer or other electronic data processing device, one or more of the tasks, steps, processes, methods, and/or functions described herein are completed or otherwise performed. Suitably, the listing of code or other like instructions or software or firmware is implemented as and/or recorded, stored, contained, or included in and/or on a non-transitory computer and/or machine readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, methods, functions, elements, and/or components described herein may be implemented on and/or embodied in one or more general purpose computers, special purpose computer(s), a programmed microprocessor or microcontroller, and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, methods, and/or functions described herein can be used.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obvious modifications and alterations will occur to others upon reading and understanding the present specification. It is intended that the inventive subject matter be construed as including all such modifications and alterations insofar as they come within the scope of the appended claims or the equivalents thereof.

1. A method for verifying a cardholder name associated with a payment device used in connection with an electronic card-not-present transaction conducted over a network, said method comprising:
maintaining, with at least one processor, a database including a plurality of records pertaining to historically processed transactions, each record including an indication of a primary account number of a payment device and a cardholder name used to conduct a transaction to which the record pertains;
receiving, at a name verification server, a cardholder name verification request sent over a data communications network from a merchant server in response to a customer choosing to check-out from a merchant associated with the merchant server, said cardholder name verification request including a submitted primary account number of a payment device and a submitted cardholder name, the name verification server independent of an issuer system associated with an issuer institution that issued the primary account number;
querying, with at least one processor, the database to identify one or more records that include an indication of a primary account number that matches the submitted primary account number included in the cardholder name verification request;
comparing, with at least one processor, at least one cardholder name in the identified one or more records to the submitted cardholder name included in the cardholder name verification request;
determining, with at least one processor, whether or not there is a sufficient match resulting from said comparing;
generating, with at least one processor, a name verification response, wherein a content of said name verification response is established at least partially based on determining whether or not there is a sufficient match; and
sending the name verification response to the merchant server over the data communications network.

2. The method of claim 1, further comprising:
updating the database with an additional record, said additional record pertaining to the electronic card-not-present transaction for which the cardholder name verification request was received.

3. The method of claim 1, wherein said additional record includes:
an indication of the submitted primary account number of a payment device included in the cardholder name verification request;
the submitted cardholder name included in the cardholder name verification request; and
the name verification response generated in reply to the name verification request.

4. The method of claim 1, wherein the name verification response indicates that the submitted cardholder name is valid when the determination is made that there is a sufficient match resulting from said comparing, otherwise the name verification response indicates that the submitted cardholder name is invalid when the determination is made that there is not a sufficient match resulting from said comparing.

5. The method of claim 1, further comprising:
calculating a confidence score indicative of a confidence that the name verification response is accurate.

6. The method of claim 5, further comprising:
counting a number of identified records which include the at least one cardholder name that sufficiently matches the submitted cardholder name included in the cardholder name verification request, wherein calculating the confidence score is based at least partially on the number of identified records.

7. The method of claim 1, wherein receiving the cardholder name verification request, querying the database to identify the one more or more records, comparing the cardholder name, determining whether or not there is a sufficient match, and generating the name verification response are performed by at least one processor of the name verification server.

8. A system for verifying a cardholder name associated with a payment device used in connection with an electronic card-not-present transaction conducted over a network, said system comprising:
a database including a plurality of records pertaining to historically processed transactions, each record including an indication of a primary account number of a payment device and a cardholder name used to conduct a transaction to which the record pertains; and
a name verification server comprising at least one processor, said name verification server programmed or configured to:
receive a cardholder name verification request sent over a data communications network from a merchant server in response to a customer choosing to check-out from a merchant associated with the merchant server, said cardholder name verification request including a submitted primary account number of a payment device and a submitted cardholder name, the name verification server independent of an issuer system associated with an issuer institution that issued the primary account number;
query the database to identify one or more records that include an indication of a primary account number that matches the submitted primary account number included in the cardholder name verification request;
compare at least one cardholder name in the identified one or more records to the submitted cardholder name included in the cardholder name verification request;
make a determination whether or not there is a sufficient match resulting from said comparison;
generate a name verification response, wherein a content of said name verification response is established at least partially based on said determination; and
send the name verification response to the merchant server over the data communications network.

9. The system of claim 8, wherein said name verification server is further programmed or configured to:
update the database with an additional record, said additional record pertaining to the electronic card-not-present transaction for which the cardholder name verification request was received.

10. The system of claim 8, wherein said additional record includes:
an indication of the submitted primary account number of a payment device included in the cardholder name verification request;
the submitted cardholder name included in the cardholder name verification request; and
the name verification response generated in reply to the name verification request.

11. The system of claim 8, wherein the name verification response indicates that the submitted cardholder name is valid when the determination is made that there is a sufficient match resulting from said comparing, otherwise the name verification response indicates that the submitted cardholder name is invalid when the determination is made that there is not a sufficient match resulting from said comparing.

12. The system of claim 8, wherein said name verification server is further programmed or configured to:
calculate a confidence score indicative of a confidence that the name verification response is accurate.

13. The system of claim 11, wherein said name verification server is further programmed or configured to:
count a number of identified records which include the at least one cardholder name that sufficiently matches the submitted cardholder name included in the cardholder name verification request, wherein calculating the confidence score is based at least partially on the number of identified records.

14. A computer program product for verifying a cardholder name associated with a payment device used in connection with an electronic card-not-present transaction conducted over a network, comprising at least one non-transitory computer-readable medium including program instructions that, when executed by at least one processor, cause the at least one processor to:
maintain a database including a plurality of records pertaining to historically processed transactions, each record including an indication of a primary account number of a payment device and a cardholder name used to conduct a transaction to which the record pertains;
receive a cardholder name verification request sent over a data communications network from a merchant server in response to a customer choosing to check-out from a merchant associated with the merchant server, said cardholder name verification request including a submitted primary account number of a payment device and a submitted cardholder name, the name verification server independent of an issuer system associated with an issuer institution that issued the primary account number;
query the database to identify one or more records that include an indication of a primary account number that matches the submitted primary account number included in the cardholder name verification request;
compare at least one cardholder name in the identified one or more records to the submitted cardholder name included in the cardholder name verification request;
make a determination whether or not there is a sufficient match resulting from said comparison;
generate a name verification response, wherein a content of said name verification response is established at least partially based on said determination; and
send the name verification response to the merchant server over the data communications network.

15. The computer program product of claim 14, wherein the program instructions further cause the at least one processor to:
update the database with an additional record, said additional record pertaining to the electronic card-not-present transaction for which the cardholder name verification request was received.

16. The method of claim 2, further comprising:
generating a hash identifier based on hashing the submitted primary account number; and
substituting the hash identifier for the submitted primary account number in the additional record stored in the database.

17. The system of claim 9, wherein the name verification server is further programmed or configured to:
generate a hash identifier based on hashing the submitted primary account number; and
substitute the hash identifier for the submitted primary account number in the additional record stored in the database.

18. The computer program product of claim 15, wherein the program instructions further cause the at least one processor to:
generate a hash identifier based on hashing the submitted primary account number; and
substitute the hash identifier for the submitted primary account number in the additional record stored in the database.
